(19) United States
(12) Patent Application Publication
(10) Pub. No.: US 2022/0140654 A1
(43) Pub. Date: May 5, 2022

(54) WIRELESS POWER TRANSMISSION SYSTEM

(71) Applicant: POWERMAT TECHNOLOGIES LTD., Petach Tikva (IL)

(72) Inventor: Itay SHERMAN, Petach Tikva (IL)

(73) Assignee: POWERMAT TECHNOLOGIES LTD., Petach Tikva (IL)

(21) Appl. No.: 17/427,126

(22) PCT Filed: Feb. 6, 2020
(86) PCT No.: PCT/IB2020/050960

§ 371 Date: Jul. 30, 2021

Related U.S. Application Data
(60) Provisional application No. 62/802,259, filed on Feb. 7, 2019.

(51) Int. Cl. H02J 50/12

(52) U.S. Cl. CPC H02J 50/12

(57) ABSTRACT

According to a first aspect of the present disclosed subject matter, A wireless power transmission system configured to utilize existing power-line wires of a structure, having a switch and a load, the system comprising: a transmitter configured to utilize a hot transmitter (Tx) coil having one end and another end, wherein the hot Tx coil comprising: a first selective frequency short element connecting a phase wire and a neutral wire that power the transmitter; a first conductor connecting the phase to the one end; a second selective frequency short element connected in parallel to a first pole and a second pole of the switch; a second conductor connecting the first pole of the switch to the another end, wherein the existing power-line wires connect the second pole of the switch to one pole of the load and another pole of the load to the neutral, and wherein the first element and the second element and the first conductor and the second conductor form the hot Tx coil operable at the selective frequency.

### TECHNICAL FIELD

The present disclosed subject matter relates to wireless power charging systems. More particularly, the present disclosed subject matter relates to utilizing existing power-line wiring for enlarging a transmitter coil of a wireless transmitting system.

### CROSS-REFERENCE TO RELATED APPLICATION

This application claims priority under 35 U.S.C. § 119(e) from co-pending; U.S. Provisional Patent Application No. 62/802,259, by Itay Sherman, titled “In Wall Wireless Power Supply”, filed on Feb. 7, 2019, which is incorporated in its entirely by reference for all purposes.

### BACKGROUND

Growing demand for wireless power charging systems, led to dramatic deployments increase, in a wide variety of venues, raises the need for increasing the effective charging distance between a transmitter and a receiver.

These venues are structures, such as office spaces, residential rooms, restaurants, commercial facilities, or the like. Such structures typically have power-line wiring installation of cabling and associated devices such as switches, distribution boxes, receptacles (outlets) and light fittings. The power-line wiring installation is usually based on copper conductors because of their multiple beneficial properties, such as high electrical conductivity.

Wireless charging eliminates the need of cable-chargers for charging mobile phones and other cordless devices. With a wireless charger, a battery inside the cordless devices can be charged by simply placing the device adjacent to a wireless power transmitter. This capability is essentially based on Faraday's law of induced voltage, and utilize inductive coils for wireless power transmission.

### BRIEF SUMMARY

According to a first aspect of the present disclosed subject matter, A wireless power transmission system configured to utilize existing power-line wires of a structure, having a switch and a load, the system comprising: a transmitter configured to utilize a hot transmitter (Tx) coil having one end and another end, wherein the hot Tx coil comprising: a first selective frequency short element connecting a phase wire and a neutral wire that power the transmitter; a first conductor connecting the phase to the one end; a second selective frequency short element connected in parallel to a first pole and a second pole of the switch; a second conductor connecting the first pole of the switch to the another end, wherein the existing power-line wires connect the second pole of the switch to one pole of the load and another pole of the load to the neutral, and wherein the first element and the second element and the first conductor and the second conductor form the hot Tx coil operable at the selective frequency.

In some exemplary embodiments, the second conductor is routed sustainably apart of the existing power-line wires that connect the load to the neutral

In some exemplary embodiments, the transmitter is integrated within at least one switch disposed in the structure.

In some exemplary embodiments, the transmitter is galvanically isolated from the hot Tx coil by an output transformer.

In some exemplary embodiments, the first element and the second element are capacitors.

According to another aspect of the present disclosed subject matter, a wireless power transmission system configured to utilize existing power-line wires of a structure, the system comprising: a transmitter configured to utilize a GND transmitter (Tx) coil having one end and another end, wherein the GND Tx coil comprising: a first conductor connecting the one end to a first outlet ground terminal, and a second conductor connecting the another end to a second outlet ground terminal; and wherein the first outlet ground terminal and the second outlet ground terminal are connected by ground wires of the existing power-line wires for forming the GND Tx coil.

In some exemplary embodiments, the first outlet ground terminal and the second outlet ground terminal are connected in a junction box that is distant from the first outlet and the second outlet.

In some exemplary embodiments, the transmitter is integrated within at least one outlet disposed in the structure.

In some exemplary embodiments, the transmitter is galvanically isolated from the second Tx coil by an output transformer.

In some exemplary embodiments, the hot Tx coil and the GND Tx coil allow for charging at least one receiver situated substantially away from the transmitter.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1A is showing a commonly used (prior art) electrical plan of a structure;

FIG. 1B is showing a commonly used (prior art) wiring diagram of a structure;

FIG. 2 shows a block diagram of a wireless power transmission system, in accordance with some exemplary embodiments of the disclosed subject matter;

FIG. 3 shows a block diagram of another wireless power transmission system, in accordance with some exemplary embodiments of the disclosed subject matter;

FIG. 4 illustrates a deployment of the wireless power transmission system, of FIG. 2, in a room of the structure, in accordance with some exemplary embodiments of the disclosed subject matter; and

FIG. 5 illustrates a deployment of the wireless power transmission system, of FIG. 3, in a room of the structure, in accordance with some exemplary embodiments of the disclosed subject matter.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

An objective of the present disclosure is expending the transmitting range of the transmitter (Tx) by enlarging the Tx coil size. In some exemplary embodiments, the wireless power transmission system of the present disclosure is adapted to implement the transmitter coil with power-line wires of a structure. In another words, the present disclosure system is configured to utilize existing power-line wires of a structure as a transmitter coil.

It should be noted that the term “structure” refers, in this present disclosure, to at least one room, an office space, a partitioned part of a building, a store, a classroom, a restaurant, and any combination thereof, or the like. It should also be noted that the solution provided by this present disclosure is designed to utilize the existing power-line wires, whether they are installed in-wall or external to the wall. It should be appreciated that a plurality of wireless power transmitters can be used in the structure, e.g. one Tx per room of the structure.

One technical solution is implementing the Tx coil with ground (GND) wires, of the existing power-line wires, so that the GND wires form one loop that acts as a transmitter coil.

Another technical solution is implementing the Tx coil with segments of a phase-wire used to power a load, for example, a light fixture of the structure. In some exemplary embodiments, the segments are: a phase (AC power-line) wire connecting a first pole of a switch to a junction box (AC feed to the structure); a switched phase wire connecting a second pole of the switch to a terminal of a load; a neutral wire connecting another terminal of the load to the junction box. Connecting the three segments in series with a transformer of Tx forms a loop that form a large size Tx coil.

It should be noted that the load can be any switched electrical component, such as for example a light fixture, a boiler, a switched receptacle, or the like.

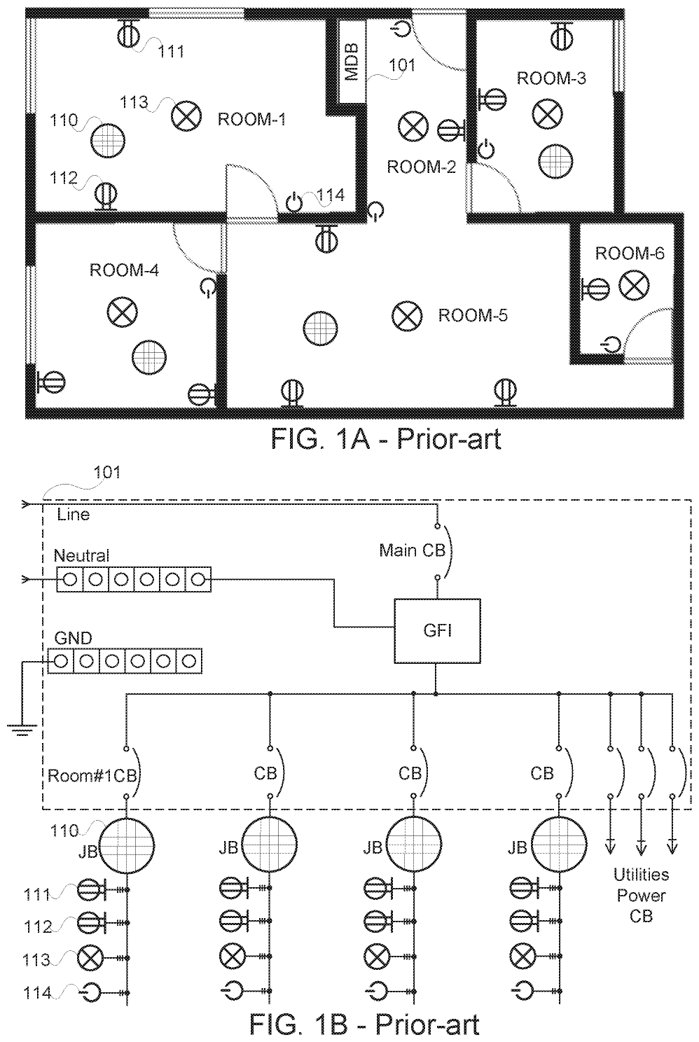

Referring now to FIGS. 1A and 1B showing a commonly used electrical plan and wiring diagram of a structure having six rooms. The electrical plan depicts locations of typical electrical components, such as light fixtures, outlets, light switches, and junction boxes that are spread in the rooms of the structure. Additionally, the structure comprises a main distribution box (MDB) 101. Typical residential or offices can be powered by single, dual or three phase AC power. For the sake of simplifying the description of the present disclosure, FIG. 1B depicts a single-phase wiring diagram, however the solution provided by this present disclosure can be utilized in dual and three phase wiring system as well.

The MDB 101 is a box incorporating power-line feed, i.e. phase, neutral and GND, from which the GND and the neutral are directly distributed to different circuits of the structure by means of junction boxes (JB) or directly to utility loads. The phase, also known as line or hot, is divided inside the MDB to the different circuits, wherein each circuit is protected by a circuit breaker, after which each circuit is distributed to different distribution boxes or directly to utility loads. The MDB 101 also comprises a main circuit breaker and a ground fault interrupter (GFI) as a protection for the entire AC power system.

In some exemplary embodiments, a system of the present disclosure can be deployed in a room, such as, for example, room 1 depicted in FIGS. 1A and 1B, which comprises outlets 111 and 112, switch 114, load 113, and junction box (JB) 110. The JB 110 is used for connecting different electrical components of room 1 with each other and/or the feed from PDB 101.

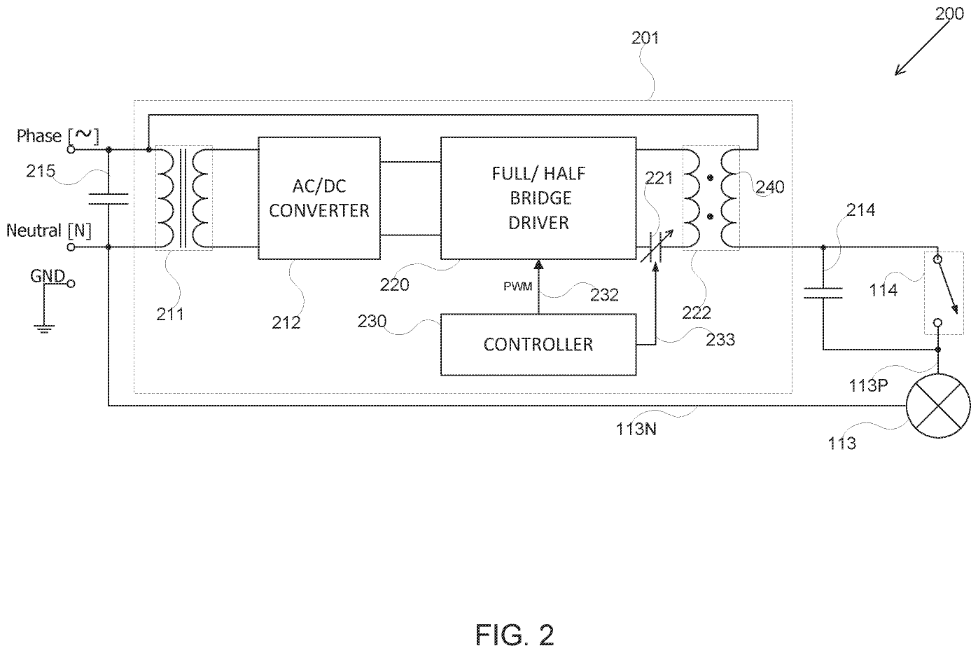

Referring now to FIG. 2 showing a block diagram of a wireless power transmission system 200, in accordance with some exemplary embodiments of the disclosed subject matter. The wireless power transmission system 200 is utilized for charging a user's chargeable device (not shown) that is placed in the same room of the system's transmitter.

In some exemplary embodiments, system 200 is configured to utilize existing power-line wires of load 113 circuit, of a room of the structure, for implementing the Tx coil.

In some exemplary embodiments, the wireless power transmission system 200 can comprise a transmitter (Tx) 201. The Tx can be comprised of a step-down transformer 211, an AC to DC converter 212; a controller 230; and a full/half bridge driver 220 coupled with output power transformer 222.

In some exemplary embodiments, the step-down transformer 211 and the AC to DC converter 212 form together a power-supply designated to satisfy the Tx 201 power needs including transmission power and components supply.

In some exemplary embodiments, controller 230 can be a central processing unit (CPU), a microprocessor, an electronic circuit, an integrated circuit (IC), or the like. Additionally, or alternatively, controller 230 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). In some exemplary embodiments, controller 230 can be utilized to perform computations required by Tx 201 or any of its subcomponents.

In some exemplary embodiments, controller 230 comprises a semiconductor memory component (not shown). The memory can be persistent or volatile memory, such as for example, a flash memory, a random-access memory (RAM), a programable read only memory (PROM), a re-programmable memory (FLASH), and any combination thereof, or the like.

In some exemplary embodiments, the memory can be configured to retain program code to activate controller 230 to perform acts associated with determining a pulse width modulation (PWM) signal that controls the full or half bridge driver 220. In some exemplary embodiments, the controller 230 can utilize its memory to retain connectivity software, monitoring information, configuration and control information, as well as application associated with charging management of the present disclosure.

In some exemplary embodiments, controller 230 can be configured to communicate with the chargeable device (not shown) based on protocols that comply with communications standards, such as power matters alliance (PMA); wireless power consortium (WPC) and AirFuel Alliance. Additionally, or alternatively, controller 230 can be provided with a radio transceiver, such as, for example, Bluetooth, Wi-Fi, or the like, for satisfying the Tx 201 communicate needs, for example, wireless power functionality and information associated with utilizing existing power-line wires.

According to these communication methods, but not limited to, the controller 230 can be configured to acquire user's credentials from the device in order to authenticate users for granting and regulating charging services. Additionally, or alternatively, the controller 230 can be also configured to acquire power requirements of the user's device.

In some exemplary embodiments, Tx 201 comprises a driver 220 configured to drive AC current through transformer 222. Driver 220 can adjust the output current flowing through a primary coil of transformer 222 by modulating an operating frequency and/or duty cycle of the current flowing through the transformer 222. In some exemplary embodiments, a PWM signal 232 generated in the controller 230 tunes the modulation to satisfy the power requirements determined by the controller based on parameters such as peak current, average of absolute current, RMS current, amplitude of first harmonic, polarity, and any combination thereof, or the like.

In some exemplary embodiments of the disclosed subject matter, a transmitter of system 200 can be integrated within a housing of a receptacle, a switch and any combination thereof, or the like. As such, the Tx 201 can be provided as a single package incorporating the transmitter and the receptacle, or the like.

In some exemplary embodiments, controller 230 adjusts frequency and duty cycle of the output power signal of driver 220 by means of the PWM signal 232. The frequency of the power signal can either range between 100 KHz to 200 Khz or specifically set to 6.78 Mhz. The power signal drives a resonant circuit comprising the output power transformer 222 and a variable matching capacitor 221 that is controlled by signal 233 of the controller to match a required resonance frequency. It should be appreciated that transformer 222 is used in the embodiment depicted in FIG. 2, for galvanically isolating the AC power from the driver of Tx 201.

In some exemplary embodiments, the wireless power transmission system 200 is configured to use a transmitter coil formed from wires of the load 113 circuit of a room of the structure, which are connected in series, with a secondary coil 240 of output transformer 222, (hereinafter: “a GND-Tx-coil”). It should be noted that the secondary coil 240 is used for passing power generated by driver 220 to the GND-Tx-coil. It will be appreciated that, utilization of the GND-Tx-coil expands the inductive distribution range of the Tx due to longer length of the conductors, i.e. wires of load 113 circuit, and their perimeter-layout, in the room. Accordingly, longer conductors and larger perimeter-layout yields a bigger-size 1^{st}-Tx coil.

In some exemplary embodiments, driver 220 uses transformer 222 to power the GND-Tx-coil, wherein transformer 222 is connected in series to the GND-Tx-coil by means of secondary coil 240. In some exemplary embodiments of system 200, the GND-Tx-coil is a circuit comprising the following wires segments:
a. a wire connecting the phase that feeds power to the Tx 201, to one end of coil 240;
b. a wire connecting another end of coil 240 to a pole of switch 114 and capacitor 214, which are parallelly connected together;
c. a wire connecting an opposite pole of switch 114 and capacitor 214 to load 213 positive-terminal;
d. a neutral wire 113N connecting a negative terminal of load 113 to the neutral of the power-line and capacitor 215 that closes circuit of the GND-Tx-coil.

It should be appreciated that capacitors 214 and 215 behave as selective frequency short-circuit elements. While switch 114 is off, capacitor 214 maintain high impedance for AC power-line, i.e. 50/60 Hz, and low impedance for high frequency (greater than 100 KHz) power signal driven by the driver 220 trough transformer 222. While switch 114 is off, the AC power-line impedance drops; however, the impedance for the high frequency is kept low no matter what the state of the AC power switch is. Hence, capacitors 214 is in play when switch 114 is off while capacitors 215 is constantly in play.

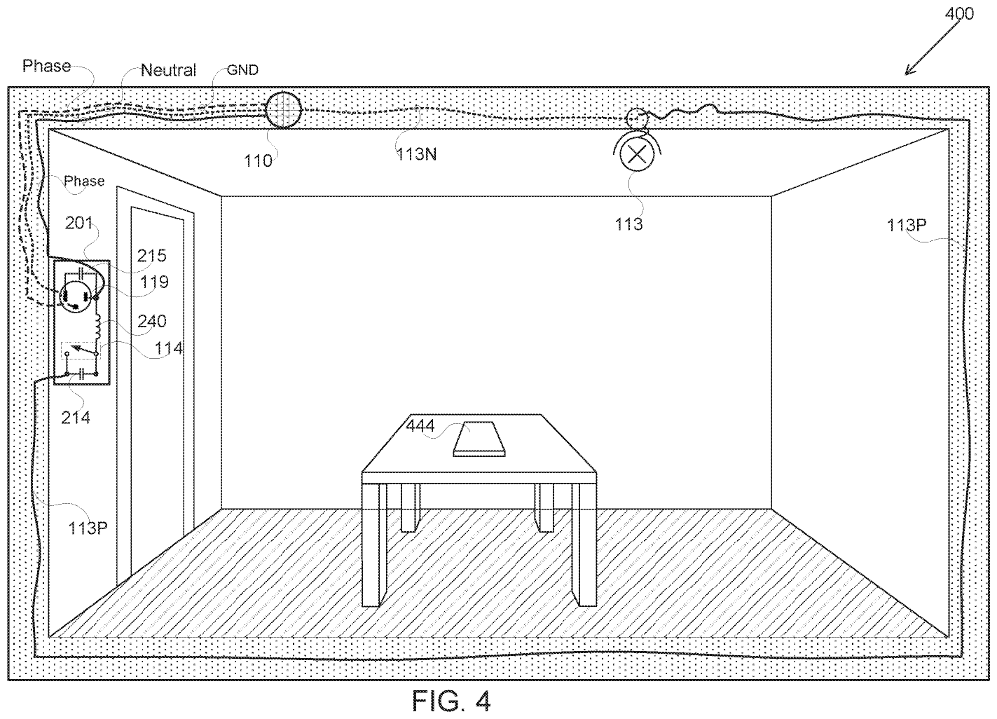

Referring now to FIG. 4 illustrating a deployment lay-out of the wireless power transmission system 200 of FIG. 2, in a room 400 of the structure, in accordance with some exemplary embodiments of the disclosed subject matter.

In some exemplary embodiments, power-line (phase, neutral and GND) from JB 110, feeds outlet 119 used for powering the Tx201. Tx201 is configured for expanding its Tx coil range, i.e. creating sufficient magnetic flux that can wirelessly charge a distant device (receiver), such as device 444.

In some exemplary embodiments, the secondary coil 240 of Tx201 acts as a current source for the GND-Tx-coil. The GND-Tx-coil made of the following wires, which are connected in a way that yield a largest possible perimeter-layout of the GND-Tx-coil.
a. a wire connecting the phase of outlet 119 to one end of coil 240.
b. a wire connecting another end of coil 240 to switch 114 and capacitor 214.
c. a wire 113P connecting the opposite ends of switch 114 and capacitor 214 to load (light) 213.
d. wire 113N connecting the negative terminal of load 113 to capacitor 215 that closes the circuit of the GND-Tx-coil.

It will be appreciated that in typical power-line wiring, a substantially long distance between junction box 110 and receptacles, i.e. power outlets, switches, or the like facilitates expanding the inductive distribution range of the Tx due to longer length of the wires and their perimeter-layout.

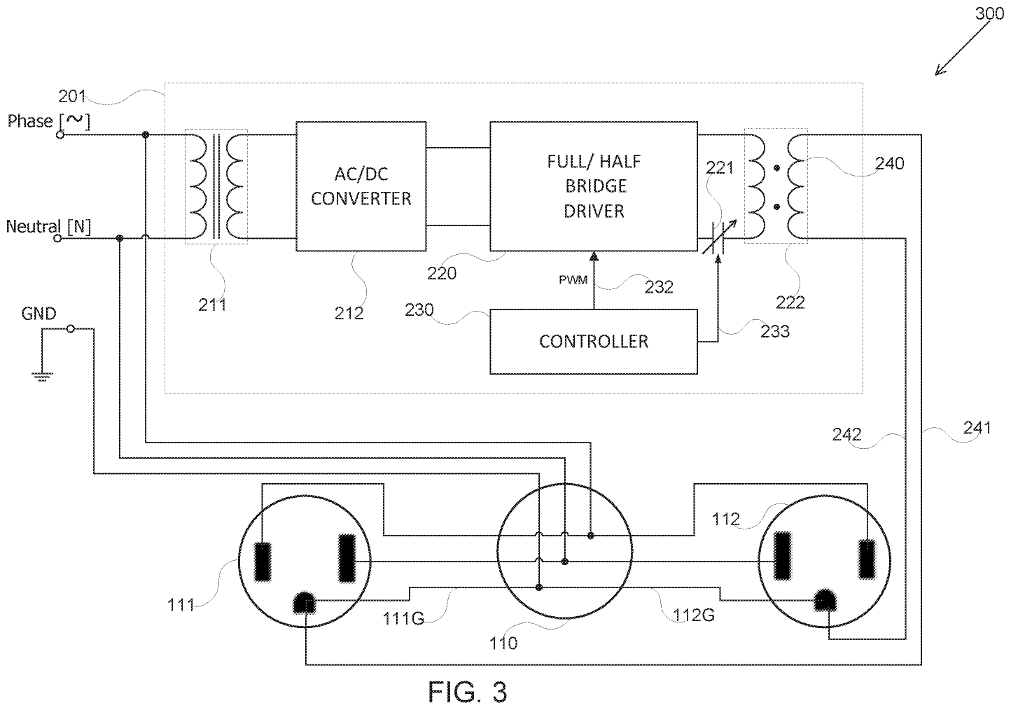

Referring now to FIG. 3 showing a block of a wireless power transmission system 300, in accordance with some exemplary embodiments of the disclosed subject matter. The wireless power transmission system 300 is utilized for charging a user's chargeable device, such as device 444 of FIG. 4, that is placed at the same room as the system's transmitter.

In some exemplary embodiments, system 300 is configured to utilize existing power-line ground wires of a room of the structure for implementing a HOT-Tx-coil. In some exemplary embodiments, the wireless power transmission system 300 can comprise the same transmitter (Tx) 201 as described for FIG. 2.

In some exemplary embodiments of the disclosed subject matter, a transmitter of system 300 can be integrated within a housing of a receptacle, a switch and any combination thereof, or the like. As such, the Tx 201 can be provided as a single package incorporating the transmitter and the receptacle, or the like.

In some exemplary embodiments, the wireless power transmission system 200 is configured to use a transmitter coil formed from GND wires of outlets, such as outlets 111 and 112 of a room of the structure that are connected in series with a secondary coil 240, of output transformer 222, (hereinafter: “a GND-Tx-coil”). It should be noted that the secondary coil 240 is used for passing power, current source generated by driver 220, to the GND-Tx-coil.

Additionally, or alternatively, system 300 can be provided with Tx 201 that is not equipped with transformer 222. In such embodiments, the ends of the HOT-Tx-coil can be connected directly to the output of driver 220 (not shown).

It will be appreciated that the utilization of the HOT-Tx-coil expands the inductive distribution range of the Tx due to longer length of the conductors, i.e. GND wires of outlets 111 and 112, and their perimeter-layout, in the room. Accordingly, longer conductors and larger perimeter-layout yield a bigger-size HOT-Tx-coil.

In some exemplary embodiments, driver 220 uses transformer 222 to power the GND-Tx-coil by means of the transformer 222, secondary coil 240 that is connected in series with the GND-Tx-coil. In some exemplary embodiments of system 300, the GND-Tx-coil is comprised of the following wires segments:
a. wire 241 connecting the GND of outlet 111 to one end of coil 240;
b. wire 242 connecting the GND of outlet 112 to another end of coil 240;
c. existing GND wires 111G and 112G that connects GND legs of outlets 111 and 112 together.

In the alternative embodiments of system 300 (transformer 222 not in use), a resonant circuit is formed with a variable capacitor 221 and the GND-Tx-coil that is directly connected to the driver. The GND-Tx-coil can be comprised of the following wires segments:
a. wire 241 connecting the GND of outlet 111 to one output of driver 220 (not shown);
b. wire 242 connecting the GND of outlet 112 to another end output of driver 220 via capacitor 221 (not shown);
c. existing GND wires 111G and 112G that connect GND legs of outlets 111 and 112 together.

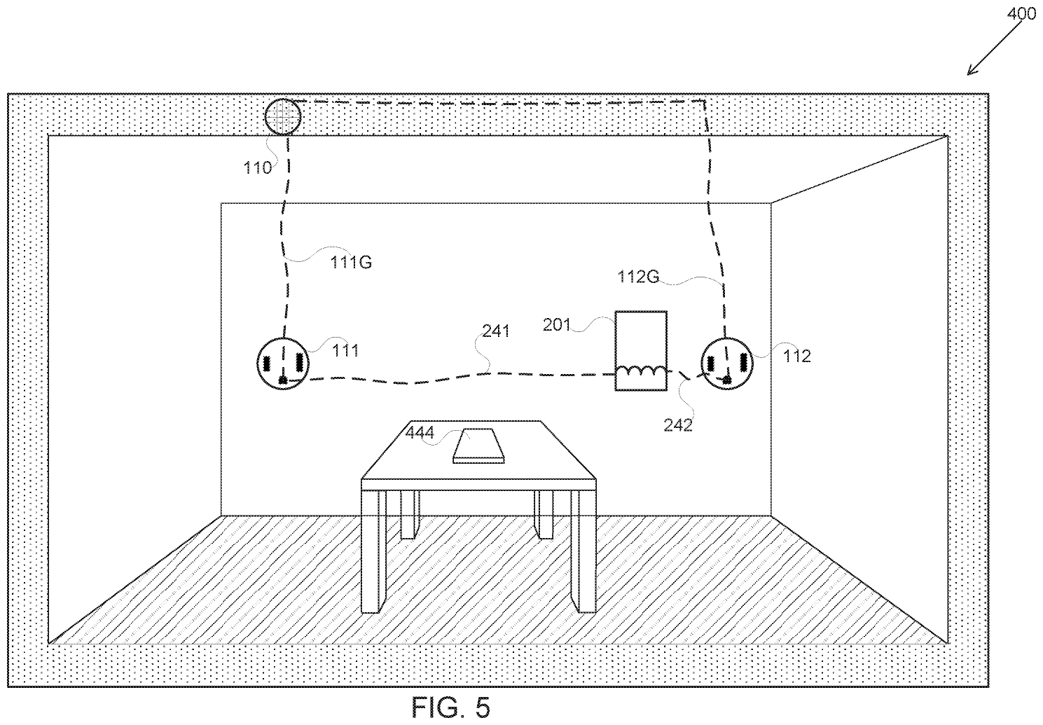

Referring now to FIG. 5 illustrating deployment of the wireless power transmission system 300 of FIG. 3, in a room 500 of the structure, in accordance with some exemplary embodiments of the disclosed subject matter.

In some exemplary embodiments, outlet 119 can be used for powering the Tx201. The Tx201 is configured for expanding its Tx coil range, i.e. creating sufficient magnetic flux that can wirelessly charge a distant device (receiver) such as device 444.

In some exemplary embodiments, the secondary coil 240 of Tx201, acts as a current source for the GND-Tx-coil. The GND-Tx-coil made of the following wires, which are connected in a way that yield a largest possible perimeter-layout of the HOT-Tx-coil:
a. wire 241 connecting the GND of outlet 111 to one end of coil 240;
b. wire 242 connecting the GND of outlet 112 to another end of coil 240;
c. an existing GND wires 111G and 112G, connecting GND legs of outlets 111 and 112 together in JB 110.

In the alternative embodiment of system 300, where the GND-Tx-coil is directly connected to the driver, the GND-Tx-coil is comprised of the following wires segments:
a. wire 241 connecting the GND of outlet 111 to one output of driver 220 (not shown);
b. wire 242 connecting the GND of outlet 112 to another end output of driver 220 via capacitor 221 (not shown);
c. existing GND wires 111G and 112G that connect GND legs of outlets 111 and 112 together.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A wireless power transmission system configured to utilize existing power-line wires of a structure, having a switch and a load, the system comprising:
a transmitter configured to utilize a hot transmitter (Tx) coil having one end and another end, wherein the hot Tx coil comprising: a first selective frequency short element connecting a phase wire and a neutral wire that power the transmitter;
a first conductor connecting the phase to the one end;
a second selective frequency short element connected in parallel to a first pole and a second pole of the switch;
a second conductor connecting the first pole of the switch to the another end, wherein the existing power-line wires connect the second pole of the switch to one pole of the load and another pole of the load to the neutral, and
wherein the first element and the second element and the first conductor and the second conductor form the hot Tx coil operable at the selective frequency.

2. The system of claim 1, wherein the second conductor is routed sustainably apart of the existing power-line wires that connect the load to the neutral

3. The system of claim 1, wherein the transmitter is integrated within at least one switch disposed in the structure.

4. The system of claim 1, wherein the transmitter is galvanically isolated from the hot Tx coil by an output transformer.

5. The system of claim 1, wherein the first element and the second element are capacitors.

6. The system of claim 1, wherein the hot Tx coil allows for charging at least one receiver situated substantially away from the transmitter.

7. A wireless power transmission system configured to utilize existing power-line wires of a structure, the system comprising:
a transmitter configured to utilize a GND transmitter (Tx) coil having one end and another end, wherein the GND Tx coil comprising:
a first conductor connecting the one end to a first outlet ground terminal, and
a second conductor connecting the another end to a second outlet ground terminal; and
wherein the first outlet ground terminal and the second outlet ground terminal are connected by ground wires of the existing power-line wires for forming the GND Tx coil.

8. The system of claim 7, wherein the first outlet ground terminal and the second outlet ground terminal are connected in a junction box that is distant from the first outlet and the second outlet.

9. The system of claim 7, wherein the transmitter is integrated within at least one outlet disposed in the structure.

10. The system of claim 7, wherein the transmitter is galvanically isolated from the GND Tx coil by an output transformer.

11. The system of claim 7, wherein the GND Tx coil allows for charging at least one receiver situated substantially away from the transmitter.
